(19) United States
(12) Patent Application Publication
(10) Pub. No.: US 2022/0027812 A1
(43) Pub. Date: Jan. 27, 2022

(54) SYSTEM AND METHOD FOR STORING AND RETRIEVING A HISTORICAL ENTRY TO GENERATE A RENTER RISK REPORT

(71) Applicant: Sib BAHJAT, Colleyville, TX (US)

(72) Inventor: Sib BAHJAT, Colleyville, TX (US)

(21) Appl. No.: 17/385,670

(22) Filed: Jul. 26, 2021

Related U.S. Application Data
(60) Provisional application No. 63/056,390, filed on Jul. 24, 2020.

(51) Int. Cl. G06Q 10/06; G06Q 50/16; G06Q 30/06

(52) U.S. Cl. CPC G06Q 10/0635; G06Q 30/0645; G06Q 50/16

(57) ABSTRACT

A method and system for web-based application that authenticates a user and provides a database of multiple lessees' rental histories for verification by a potential lessor and ability to generate a renter risk report comprised of an aggregated and weighed initial renter risk score and historical renter risk score. A user application can submit credentials to a server and a hardware processor can query a database to verify the user which subsequently communicates a unique session ID to the user application. Then the user can search for the lessee history of a stored entry to either verify the history, retrieve components necessary to generate a renter risk report and/or submit a new historical entry to be associated with the lessee history for future search returns.

### CROSS-REFERENCE TO RELATED APPLICATIONS

This application claims the benefit of provisional U.S. Application No. 63/056,390 entitled “System and Method for Storing a Historical Entry” filed Jul. 24, 2020, the entirety of which is incorporated herein in its entirety.

### TECHNICAL FIELD

The present disclosure relates to a web-based application for allowing asset holders, also called lessors, the ability to verify and evaluate the residential history of a potential lessee without the need to contact references. More particularly, and not by way of limitation, the present disclosure is directed to a system and method for using a web-based application that authenticates a user and provides access to one or more databases of multiple lessees' rental histories for verification by a potential lessor, a forum for which a lessee can provide responses to historical entries, and a generated renter risk report comprising, inter alia, an initial renter risk score and historical renter risk score.

### BACKGROUND

This background section is intended to provide a discussion of related aspects of the art that could be helpful to understanding the embodiments discussed in this disclosure. It is not intended that anything contained herein be an admission of what is or is not prior art, and accordingly, this section should be considered in that light.

Upon receiving an inquiry by a potential lessee (also called a renter or tenant) to occupy and lease a lessor (also called a landlord or asset holder) owned space such as an apartment, a lessor will often be concerned about whether the potential lessee will honor their obligations under a lease. If the lessor enters into a lease agreement with a lessee and the lessee is unable or unwilling to honor their obligations, then the lessor can often suffer harm such as loss of revenue, damage to the property, legal liability, or worse. In addition, there may be contractual or legal hurdles that inhibit the lessor from being fully compensated for the suffered harm or impede the lessor from quickly remediating the bad situation. As a result, it is in the best interest of a lessor to determine the likelihood that a potential lessee will honor their obligations in order to minimize the risk that the potential lessee will turn out to not be a worthwhile entity to enter into a lease with.

Risk mitigation by the lessor is often accomplished by inquiring into the history of the lessee to determine the probability that the potential lessee will honor their obligations such as paying rent on time and occupying the property through the entire lease term by looking at the potential lessee's history. If the potential lessee has a history of paying rent on time and not breaking leases early, then it is more likely that the potential lessee will continue to do so and fulfill their obligations under a new lease. Unfortunately, a lessor is often solely dependent on the potential lessee themselves for their own history. Lessors will have to contact and comb through lessee-supplied references who cannot be trusted and reach out to previous lessors for information in hopes of determining the potential lessee's actual history. This information, however, is completely known to the potential lessee. Thus, the lessor enters into negotiations with the potential lessees at a disadvantage due to this imbalance of information.

Economists often call this type of situation adverse selection. Adverse selection occurs when one party to a potential agreement or an exchange has to make the decision to enter into the agreement while having imperfect information such as the lack of lessee history. The potential lessee, on the other hand, has complete knowledge of their own history. The result of the imbalance of information is that the lessor may have to take on more risk than it would otherwise be comfortable with if there was no adverse selection present. In turn, this risk can result in undue hardships for lessor such as entering into leases with undesirable lessee or refusal to enter into a lease with a qualified, but unverifiable, potential lessee.

What is needed is a system and method that allows for a lessor to effectively, quickly, and easily obtain the actual lessee history without being dependent on the lessee themselves for that information prior to entering into a lease with them, thereby alleviating any information imbalances and allowing for the potential renter's risk to be evaluated in a risk report. It would be advantageous to have a system and method that overcomes the disadvantages of the prior art. The present disclosure provides such a system and method.

### BRIEF SUMMARY

This summary provides a discussion of aspects of certain examples of the invention. It is not intended to limit the claimed invention or any of the terms in the claims. The summary provides some aspects but there are aspects and examples of the invention that are not discussed here.

The present disclosure includes a user application that allows for an asset holder—i.e., lessor—to quickly view and assess the reliability of a potential lessee without having to rely on the lessee for all of the relevant information. One example of the invention may include an application that initiates a user session (also called device session) with a server that can authenticate the user and determine whether the user is a lessor or lessee. Then, the server may be able to retrieve stored entries that contain a lessee's history. If the user is a lessor, then the user may be able to store a new historical entry associated with the stored entries or retrieve all of the lessee's historical entries to generate a risk report; a lessee, on the other hand, may be able to store a new historical entry that provides context to a historical entry previously stored by a current or previous lessor.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram of a method of storing a historical entry in association with a stored entry in a database according to one example of the present invention.

FIG. 2 is a schematic diagram of a system for storing a historical entry in association with a stored entry in a database on a server according to one example of the present invention.

FIG. 3 is a block diagram of the components of an initial renter rating score.

FIG. 4 is a block diagram of a historical renter risk score.

FIG. 5 is a block diagram of a renter risk report score.

FIG. 6A is a table featuring the weighed components for one example of the initial renter risk report.

FIG. 6B is a table featuring the weighed components for one example of the historical renter risk score.

FIG. 6C is a table featuring the weighed components for one example of the composite renter risk report.

FIG. 7 is a block diagram of a method for aggregating renter risk scores to generate a composite renter rating report.

FIG. 8 is a schematic diagram of a system for generating a composite renter risk report and retrieving historical entries stored on one or more databases.

### DETAILED DESCRIPTION

The present disclosure includes one or more examples of a web-based application in which a user enters a URL into a traditional web-browser or an embedded browser in a native-application. Both methods of communication allow for communicating with a database over a network such as the Internet. Then, a unique session ID (also called session identifier or session token) is created by authenticating the user. The session ID is temporary and will expire after a short time or a brief period of inactivity by the user. While the user is active and has a valid session ID, the user may send and receive data through the browser without being required to reauthenticate themselves.

When the user is authenticated, a database will be queried to determine the level of privileges associated with the user. If the user is rated as an asset holder, then a listing of all of the assets (e.g., owned properties) associated with the asset holder will be available for the asset holder to search through. Each asset may but is not required to correlate with at least one physical piece of property that the asset holder owns or is responsible for handling leasing agreements between lessees and lessors. The database contains entries for each lessee, past and present, which can be searchable by social security number or other unique identifier information. Once a user has queried the database and located the lessee in question, the user may be able to insert a lessee historical entry into the database so that the entry is associated with the lessee. For example, the new historical entry may be stored in association with a potential lessee's social security number such that the historical entry can be presented to a potential lessor along with all other historical entries associated with the potential lessee's social security number to provide the potential lessor of an accurate and update lessee history for evaluation. This lessee history can include any number of things, including payment history, number and nature of maintenance requests, complaints or fines levied on the lessee, or other miscellaneous comments that are not easily categorized. Historical entries may comprise and/or be accompanied by historical components that can be used by the asset holder to generate a historical renter risk score. Historical components may be but are not limited to successful rental payments or defective rental payments. Examples of historical components include but are not limited to rental amount component, rent term component, co-lessee indicator component, payment history component, number and nature of maintenance requests components, complaints and fines levied on the lessee component, deposit paid and refunded component, and other miscellaneous comments components.

In one or more examples, an asset holder can automate the process so that each time a periodic payment is made on time, the user is authenticated and a historical entry and/or historical component is inserted into the database, associated with the particular lessee, based on their social security number. This alleviates the need to have an actual person input the entries each and every time a historical event occurs and allows for historical entries to be made consistently, on time, and without any unintended gaps. Failures to make a periodic payment can also be input into the database, and a subsequent historical entry can be made if a delinquent payment is made, or the payment has to be written off because it was determined that the payment is unlikely to be recovered by the lessor. If another asset holder receives an application from a potential lessee, then the asset holder can access the database and perform a search using the potential lessee's social security number or other identifier.

One or more examples may include an assessment identifier that is designed to designate what type of historical entry is being stored in the database. If, for instance, a lessee provides adequate notice that he or she will not be renewing a lease and leaves the leased property in immaculate condition, the lessor may want to make a historical entry indicating these facts for a future lessor to be made aware of. In doing so, the lessor may designate the associated historical entry is a positive entry by including a positive identifier. This would allow for the lessor to filter the presented historical entries so that only the positive entries are displayed, and a potential future lessor could be made aware of the potential lessee's past positive behavior. However, if the lessee breaks a lease prior to the end of the lease term and leaves the property in disrepair, the lessor could also include a negative identifier, along with the historical entry to allow the potential lessor to be presented with only the potential lessee's negative historical entries.

There may be instances in which, despite the best intentions of a lessee and through no fault of their own, the applicant/lessee may have a negative historical entry submitted to the database for a property where they were previously a lessee. Future potential lessors may read the negative historical entry and decide to forgo entering into a lease with the applicant based on the negative historical entry. In those circumstances, the applicant may want to provide a potential lessor evaluating the applicant with the applicant's own context to the historical entry to mitigate the harmful perception created by the historical entry. The additional context may alter the potential lessor's perception of the applicant such that the negative historical entry does not dissuade the lessor from entering into a lease with the applicant.

Examples may include instances in which an applicant may have broken a lease early because of a sudden death in the family that required the applicant to move back home to take care of a younger sibling or aging parent. Other examples may include applicants that, as a lessee, had to move out of the leased property because the lease property became unlivable, and the lessor, at the time, may have entered the negative historical entry out of spite against the lessee. Allowing the lessee to respond to negative historical entries alleviates the risk that a lessee will be subject to the predations of lessors for fear that if they speak out, they may suffer a negative historical entry that could negatively affect their ability to enter into future leases with lessors that may not be aware of all of the facts and circumstances surrounding a negative historical entry.

To provide context, the applicant could be able, in one example, to access the database through the web browser and retrieve all stored entries associated with their identifier information—e.g., a social security number. The applicant could then insert an additional historical entry that could be presented to a potential lessor along with a negative historical entry. In some embodiments, the applicant may not be able to delete or remove the negative historical entry, but the applicant could provide important context that could alter a potential lessor's evaluation of the applicant.

The scope of privileges for a user may depend on the type of user that is interacting with the user application. A lessor can have access to a large assortment of entry types, search functions and tools available to them once their credentials have been authenticated. Comparatively, the scope of privileges may be more limited for a user that is a lessee. Potential embodiments may limit the scope of privileges such that the ability to make a new historical entry associated with a lessee is only available to lessor users; while lessees may only be able to store additional historical entries to an existing historical thread after a lessor has started the historical thread by storing the initial historical entry. However, alternate examples may allow for lessee/user to start new historical threads by inserting new historical entries. Often, other lessees in a complex such as an apartment may have a better understanding of a lessee's pertinent history than the lessor because the other lessee constantly lives in close proximity to each other for extended periods of time.

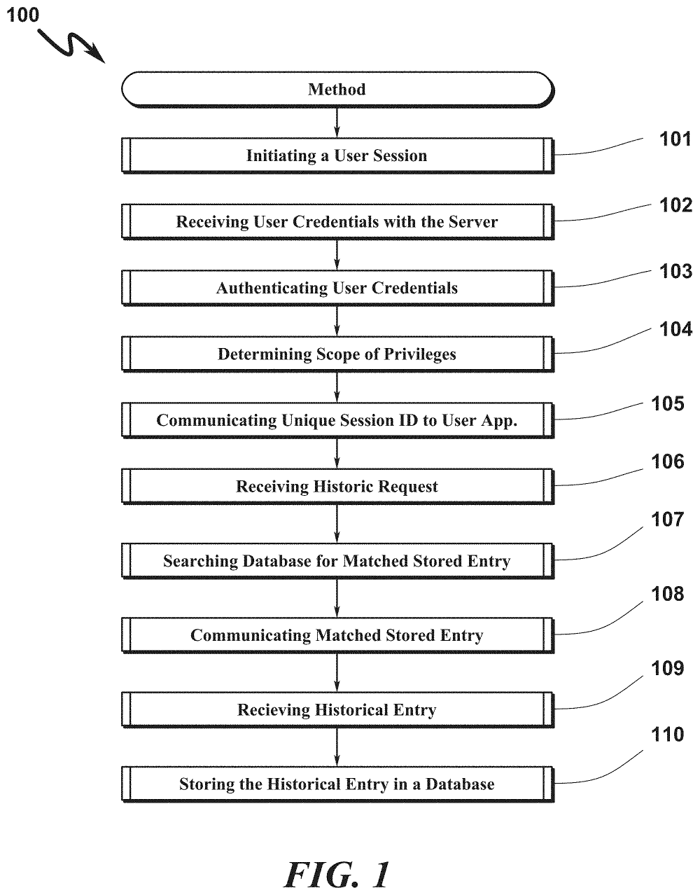

FIG. 1 is a block diagram of a method 100 of storing a historical entry in association with a stored entry in a database according to one embodiment of the present invention. A user may initiate 101 a user session by inserting a uniform resource locator (“URL”), also called a web address, into a web browser. A URL typically refers to a resource location on a computer network, and where the resource is located on the computer network. Often, the resource can be accessed or retrieved from the computer network through the URL. Alternatively, one example has a native application located on a user device that, upon user request, launches its own web application or creates a webview that presents the application to the user while being handled by a server. However, any sort of application access that allows the user to submit credentials to be received 102 by a server would be acceptable. The credentials may be submitted over a network to the server for authorization 103. The server then can query a database to search a list of authorized users for a match to the submitted user credentials.

Some examples may allow for a user to create a new authorized user to be added to the authorized user list. This could be done by submitting proof of ownership of properties that the owner intends to offer for lease to have an account created for the user. Also, contractual agreements that give authorization for a potential user to act on behalf of the property owner could also be submitted and used to provide proof of the user's authenticity.

Each account in the authorized user list may also have a scope of privileges (“SoP”) ID associated with the user account which would indicate what tools and functions would be available for the user to access. The server could determine 104 the scope of the privileges available to the user by checking the associated SoP ID. Then, the server may generate a unique session ID for the user which can be communicated to the user application 105. This session ID is usually temporary and may only associated with the user during the present user session. If the user needs to reauthenticate for some reason such as a longer than normal period of inactivity, the user can resubmit the session ID, along with whatever data the user is communicating to the server. The reauthentication may be done automatically either on the user side or at the request of the server side.

The user may make a historical request which can be received by the server 106, the request can be made through whatever means the user is accessing the server, including entering the historical request through a user interface on the web browser. The historical request can include any identifiable information that could be used to search 107 the database to be matched with a stored entry in a database comprising multiple stored entries. Each of the stored entries could be associated with a particular lessee and comprise all of the historical entries ever received by the server to be stored in the relevant database.

The server then may communicate 108 the matched stored entry to the user through a web view on the web browser. The user may simply use the system to view at least one of the stored entries associated with a lessee; however, if the user wants to submit a new historical entry, then the user may input the new historical entry into the web browser through a user interface. The new historical entry may then be communicated through a network to be received 109 by the server. Then the server may store 110 the new historical entry such that it is associated with previously matched stored entry and may be retrieved by future users who submit historical requests that are matched with the stored entry.

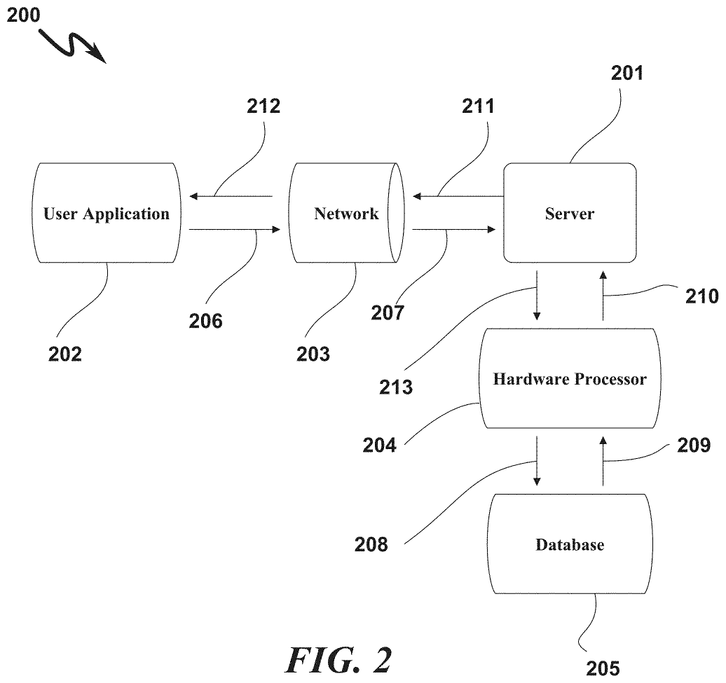

FIG. 2 is a schematic diagram of a system 200 for storing a historical entry in association with a stored entry in a database on a server according to one or more examples of the present invention. A hardware processor 204 may be coupled to a server 201 which is accessible over a network 203—e.g., the Internet—by a user application 202. The hardware processer 204 can be configured to perform operations on the server 201 as the result of an interaction with a user or automatically without user involvement. For instance, the hardware processor may initiate a user session. The user session may be initiated when a user engages with the server 201 by inputting user credentials into a user interface on a user application 202. The user credentials can be communicated 206 to the network 203 and then communicated 207 to the server 201. Communication can occur over physical channels of communication or over wireless communicators. Often, a network 203 can be composed of a variety of segments that may have different means of communicating data.

The hardware processor 204 may then receive 213 and process the user credentials from the server 201, which then queries 208 a database 205 looking for a stored user ID that matches the user credentials. If a match is found, the hardware processor 204 may, after retrieving 209 the matched stored user ID from the database 205, generate a unique session ID which is then communicated 210 to the server 201. In turn, the server 201 may communicate 211 the session ID through the network 203 so that it may be communicated 212 to the user application 202. The session ID may be temporary and can be used to reauthenticate the user at future points in time during the user session. The session ID can allow for the user application 202 to be reauthorized without requiring user credentials to be resubmitted. In one or more examples, the session ID may be a token (also called a device token or push token) which can be a unique key for the app-device combination most notable used by push notification gateways. They allow for messages to be routed such that their delivery to the correct device, along with the correct application, as intended.

Once the user application 202 has an associated session ID, a history request may then be entered into a user interface in the user application 202. A history request can be a piece of data that easily identifies a person or entity that has had prior associated historical entries input into the database 205. Typically, a history request can be names or identification numbers such as social security number and/or a full name and address. One or more examples may include a full name combined with a birthdate and social security number as the identifying segment of data used in the historical entries to associate the historical request with a stored entity. Once received by the server 201 over the network 203, the hardware processor 204 can search 208 the database 205 for a matching stored entry. If a match stored entry can be located, then the match stored entry is retrieved 209 by the hardware processor 204 and communicated 211 by the server 201 over the network and communicated 212 to the user application.

The user application 202 may then receive an historical entry to be associated with the matched stored entry. Both can be communicated to the server 201, then the hardware processor 204 stores the historical entry in the database 205 such that it is associated with the previously matched stored entry. The historical entry can be different types which can be dependent on the scope of privileges held by a user. If the user is a lessor, then the lessor may be able to create new historical entries that can detail a lessee history or store a new entry in the database. In one or more examples, a user that is a lessee may only store historical entries as a supplement to a previously created historical entry made by a lessor. Other examples, however, may allow for a lessee to make new historical entries without being a supplement to a previously lessor-created historical entry. This could be done for the purpose of providing context to an event before the lessor has misrepresented the event or add positive history associated with the lessee to the database because the lessor is unwilling to do so. The new historical entry can now be searched for and displayed to a future authorized user of the database.

Various examples may also include the utilization of application programming interfaces (“API”) at various points in the disclosed system and method. An API is a computer interface that facilitates the interaction between multiple software intermediaries. It can provide mechanisms in which calls and requests can be made by one piece of software to another, data formats to use when utilizing a piece of software, and conventions to follow. APIs can be completely customized to a particular need, or it may be designed to confirm to a particular industry standard. One example could include an API that the data processor 204 uses to query the hardware database 205 to match stored entries. Other APIs could be utilized in conjunction with the user application.

A common gateway interface (“CGI”) may be utilized by the disclosed system and method to generate web pages dynamically that are being executed by console applications being run on a server 201. A CGI can be an interface specification for servers such as web servers to execute programs such as console applications or command-line interface programs on the server 201. In one or more examples, a CGI being run on the server 201 may be used to process a historical request received from the user application (typically input by a user) and return the stored entry to the user application 202 after it has been retrieved by the hardware processor 204 that searched the database 205.

In one or more examples, historical entries may be components of a historical renter rating score that is stored in the hardware database in association with the historical entries. By retrieving the historical entries, the user may be able to generate a historical renter risk score and a renter risk report.

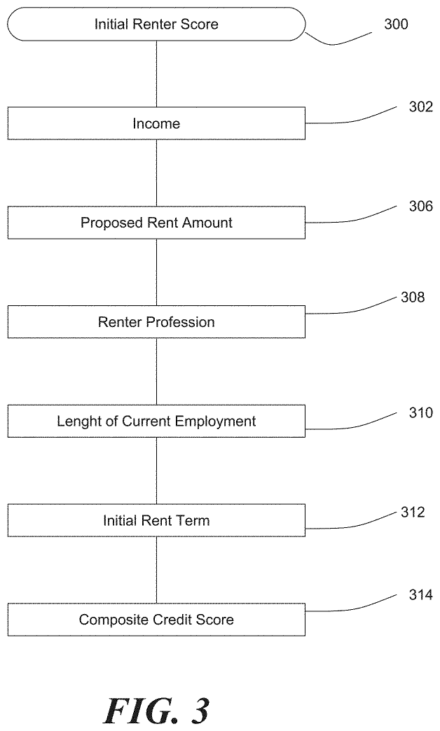

FIG. 3 is a block diagram of the components of one example of an initial renter risk score 300. Similar to a credit score, a renter risk score 300 may be a numerical value that represents the risk the renter poses at failing to fulfill the obligations of a renter such as paying rent on time. In the United States, a consumer's credit report is an aggregate of three (3) scores monitored and maintained by three (3) credit bureaus. A creditor may request a credit report which contains all of the consumer's credit scores, as well as the consumer's credit history. By examining the consumer's credit report, a creditor may more accurately gauge the credit risk the consumer looking to obtain a line of credit presents.

As with a credit score, an initial renter risk score 300 may be composed of various components. In one example, an initial renter risk score 300 may be calculated based on the contents of the renter's application. Typically, a prospective renter will submit an application that contains a wide variety of information to an asset holder, also called property owner, so that the asset holder may evaluate the renter's risk portfolio. This information tends to be facts that can be verified by an asset holder at the time the application is submitted. For instance, the renter's income 302 and profession 308 and employer may be verified by pay stubs that were submitted along with the application. Length of current employment 310 and number of jobs held within the past five (5) years maybe verified by contacting the references supplied by the prospective renter themselves. The renter's composite credit scores 314, i.e., credit report, may be obtained, with the prospective consent, from the credit bureaus previously mentioned.

The proposed rent amount 306, however, is going to be known by the asset holder, as well as the initial rent term 312, because he or she is the one setting that amount and offered the initial rent term 312 in the first place. The income 302 and proposed rent amount 306 may be combined to determine an income/debt ratio. Asset holders may look for a certain income to debt ratio to verify that the prospective renter has enough excess income to comfortably pay the rent on time for each pay period. There is no set income/debt ratio, the minimum ratio that each asset holder may expect is going to vary depending on the nature of the property and the willingness to rent by the asset holder. A common ratio is a four (4) to one (1) ratio, meaning that the asset holder, at a minimum, expects the prospective renter to bring in four (4) time the income 302 every pay period compared to the proposed rent amount 306. By requiring excess income 302, the property owner can reduce the risk of defective payment by the renter because the renter is, presumably, going to not be strapped for cash each pay period.

The initial renter risk score 300 may also include the deposit amount (not shown). By dividing the deposit amount by the proposed rent amount 306, the asset holder may generate a deposit ratio. In one example, the proper deposit ratio is a 2 to 1 ratio, meaning that the deposit amount is equal to two times the proposed renter amount. In other words, the renter's deposit would cover two (2) months of rent. There is no set standard for the proper deposit ratio, and each property owner may desire a different number, depending on the demand on the particular rental property.

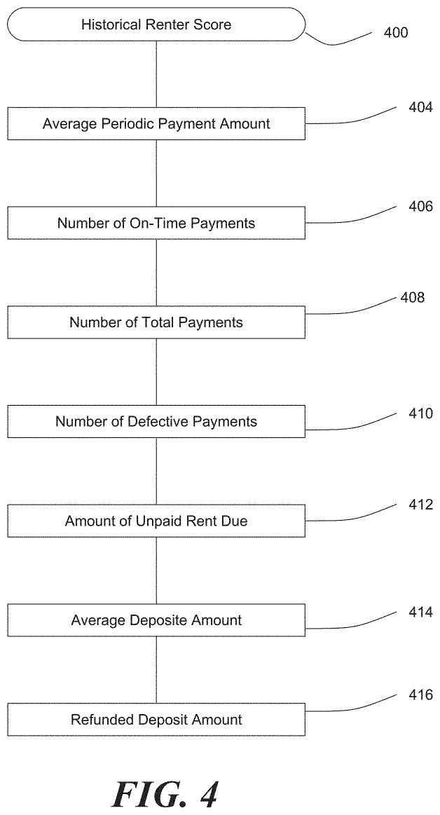

FIG. 4 is a block diagram of the components of one example of a historical renter risk score 400. In addition to an initial renter risk score, a property owner may want to know the history of the prospective renter, specifically how well the prospective renter has performed his or her renter obligations in the past. For this, a property owner may generate a historical renter risk score 400. To compile the components of the historical renter risk score 400, the property owner may utilize the system and method discussed in FIGS. 1 and 2 to request over a network, historical entries associated with the prospective renter. The historical renter risk score 400 may comprise a number of periodic payments 408, along with a number of successful payments 406. The number of periodic payments 408 and the number of successful payments 406 may be combined to generate the payment ratio. In other words, the payment ratio may be the number of successful payments divided by the number of periodic payments. Ideally, the renter's ratio would be equal to one. When the ratio is equal to one, the renter has successfully made all of his or her required payments in the full amount and on time as well. If the prospective renter has had a defective payment 410—i.e., missed a payment or not paid the full amount, then the payment ratio will be less than one.

Other components of the historical renter risk score may include the average periodic payment amount 404, the amount of unpaid rent still owed 412 by the renter, the average deposit amount 414, the average percentage of returned deposit amount 416 and the average rental period term (not shown). The period payment amount 404 and the average rental period term may be combined to form the period payment ratio. By dividing the period payment amount 404 by the average rental period term, the period payment ratio may capture the proposed renter's average rent amount per the renter's average occupancy term. Each one of these components may be weighed differently, depending on the type of risk a particular property owner may desire to take on by renting to the renter.

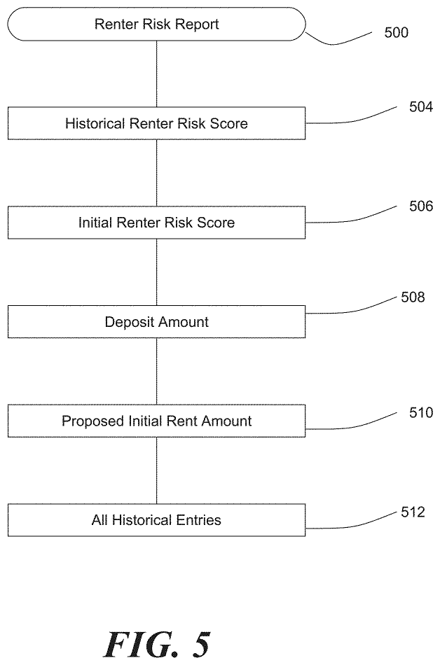

FIG. 5 is a block diagram of one example of a composite renter risk report 500. A composite renter report may be generated by aggregating and weighing both the initial renter risk score 506 and the historical renter risk score 504. If the renter applies with multiple individuals contributing to the income of the entire unit, then the initial renter risk scores 506 may be averaged and multiplied by a multiplier to account for the additional source of income. Property owners may choose different multipliers, depending on if the additional source of income adds or decreases risk. For example, if two incomes are required to meet a income/debt ratio, then the multiplier may be less than one because the renting unit now has double the chance that its income stream may be disrupted. However, if the income/debt ratio threshold is greatly exceeded, then the multiplier may be much greater than one because a disruption to one of the income sources may not result in defective payments by the renting unit.

The renter risk report 500 may also include the deposit amount 508. By dividing the deposit amount by the proposed rent amount 510, the asset holder may generate a deposit ratio. In one example, the proper deposit ratio is a 2 to 1 ratio, meaning that the deposit amount is equal to two times the proposed rent amount. In other words, the renter's deposit would cover two (2) months of rent. There is no set standard for the proper deposit ratio, and each property owner may desire a different number, depending on the demand on the particular rental property.

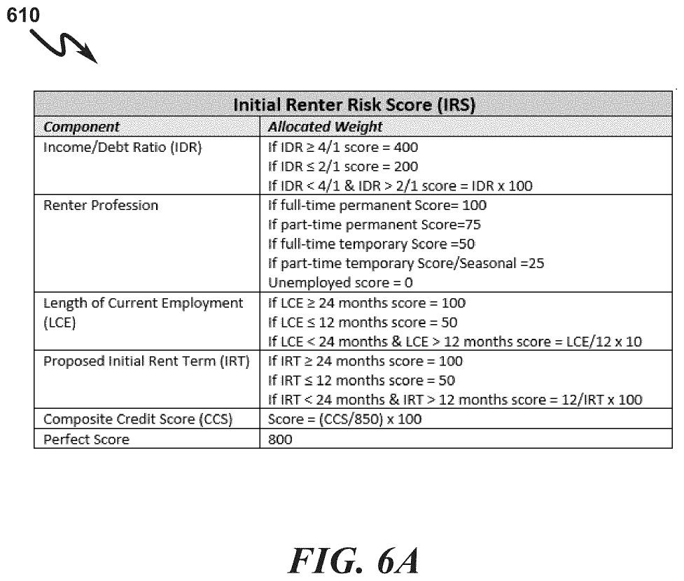

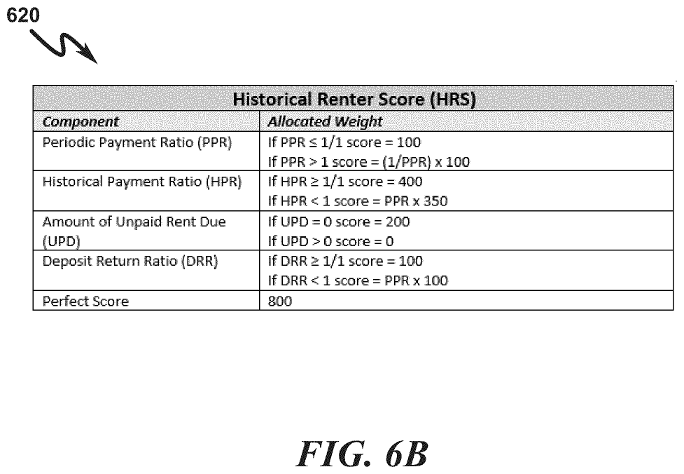

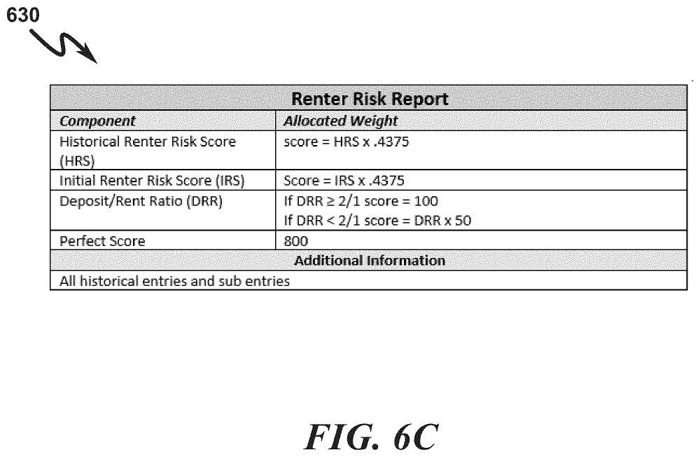

FIG. 6A is a table 610 featuring the weighed components for one example of the initial renter risk score (“IRS”). In one or more examples of the IRS, the score is comprised of the income/debt ratio (“IDR”), the renter Profession, length of current employment (“LCE”), the proposed rent term (“IRT”), the composite Credit Score (“CCS”). Components may be added or deleted based on the preference of the asset holder. In the example in FIG. 6A, the IDR is generated by dividing the proposed renter's income by the proposed rent, also called debt. The ideal IDR may vary; however, the goal of the IDR is to make sure that the proposed renter's income exceeds the periodic rent payment such that, even when the renter's life is disrupted with emergencies and/or large expenditures of cash, the renter should have enough excess income to cover the periodic rent payment. An IDR that is too low runs the risk of something as simple as a minor car accident disrupting the renter's finances such that the renter may be unable to provide sufficient payment of the periodic rent payment.

The example in FIG. 6A features a weighed IDR of four to one (4/1) being the highest classification which warrants a total of four hundred (400) points being awarded to the renter's score. Conversely, the lowest score is a two to one (2/1) IDR which only awards a score of two hundred (200) to the renter. If the IDR is somewhere in between, then the score is proportioned accordingly. Renter profession is another component that may be incorporated into the calculation of the IRS. The example in FIG. 6A features five (5) categories: (1) full-time permanent which adds one hundred (100) points to the IRS, (2) part-time permanent which adds seventy-five (75) points to the IRS, (3) full-time temporary which adds fifty (50) points to the IRS, (4) part-time temporary or seasonal which add twenty-five (25) points to the score, and (5) unemployed which adds zero (0) points to the renter's score.

Another component comprising the IRS may be the length of the renter's current employment. If the employment length is greater than or equal to twenty-four months then the renter score is increased by one hundred; less than or equal to twelve (12) months then the score is increased by fifty (50) points; and lastly, if the employment length is less than 24 months but greater than 12 months, the score is increased by a proportioned amount. In addition, one hundred (100) points may be added to the IRS if the proposed rent term is greater than or equal to twelve (12) months, fifty (50) points if the rent term is less than or equal to twelve (12) months, and a proportioned score will be added if the proposed rent term is between 24 and 12 months.

The renter's composite credit score (“CCS”) is the last component utilized to generate the IRS in the example provided in FIG. 6A. Generally, a proposed renter will include consent to request the renter's credit scores from the bureaus that maintain them. By requesting the proposed renter's credit score, the credit worthiness of the renter may be incorporated into the risk analysis performed by the asset holder. In the United States, the perfect credit score is eight hundred fifty. Once received, the proposed renter's credit score may be weighed and incorporated into the IRS. In one or more examples, a perfect IRS score may be an eight hundred (800).

The components and weight scheme featured in FIG. 6A are just one example of the procedure to generate an IRS. Other components and weighting schemes may be applied to the IRS to generate an IRS that is more suited to the asset holder's needs.

FIG. 6B is a table featuring the weighed components for one example of the initial renter risk score 620. The example of the Historical Renter Risk Score (“HRS”) features three (3) ratios: (1) periodic payment ratio (“PPR”), (2) historical payment ratio (“HPR”), and (3) the deposit return ratio (“DRR”), as well as the amount of unpaid rent due which is featured as a nominal amount in this particular example. For the PPR, the average periodic payment amount—i.e., the average historical rent payment—is divided by the proposed rent amount. The PPR is calculated in this manner in order to capture any increase in the proposed rent over the previously paid rent into the risk calculation. Just because the proposed renter has made all of their previous rent payments does not mean that there is not an increased risk of failure if the proposed rent value is higher than the previously paid rent values. In other words, as the proposed rent value goes up when compared to the previously paid rent amounts, the risker the renter.

The HPR may be calculated by dividing the number of on-time payments by the number of total payments. When analyzing the PPR, if the PPR is greater than or equal to one (1), meaning the renter never missed a historical rent payment and none of those payments were defective in any manner, then a point amount of one hundred (100) is add to the HRS. Otherwise, a point amount of the PPR multiplied by three hundred fifty (350). The asset holder may also want to capture the DRR in the risk analysis. If the proposed renter receives all or most of their deposit back, then it is safe to assume that the renter will take care of the asset and be more reliable in making timely rent payments. On the other hand, if the renter has only received a small portion of their deposits back, then the risk increases that the proposed renter will not timely make all required payments. Lastly, having any unpaid rent amount still due is a high-risk indicator that the proposed renter may not be able to meet all of their future rent obligations. If there is no unpaid rent due, then the renter's score receives an additional two hundred (200) points; however, if there is any unpaid rent still owed, then the renter's score does not receive any of those 200 points.

Other components, including other ratios and values, may be utilized to generate the HRS. In the example featured in FIG. 6B, a perfect score for an HRS is an eight hundred which is the same value as the perfect score featured in FIG. 6A for the IRS. Different weight schemes and point spreads may be utilized, depending on the risk tolerance of the asset holder.

FIG. 6C is a table featuring the weighed components for one example of the composite renter risk report 630. A Renter Risk Report (“RRR”) may be generated from the IRS and the HRS. In FIG. 6C, the example of the RRR weighs each of the IRS and HRS the same amount and then incorporates a deposit/debt ratio (“DRR”). The DDR may be intended to capture the decrease in risk derived from a larger deposit. If the deposit exceeds a period rent payment amount, then the asset holder may be able to cover defective payments by the renter if they do in fact occur. The example featured in FIG. 6C has a DDR of two to one (2/1). If the deposit meets or exceeds at least two rent payment amounts, then the asset holder is covered for at least two defective rent payments, thereby decreasing their risk. However, if the DDR is less than a 2/1 ration, then the score is proportioned accordingly.

The RRR may also incorporate other historical entries that have been stored in the historical databases. Many of these entries may provide further contexts to the risk the renter possess that may not be adequately captured in the HRS. As with the IRS and HRS, the RRR in the example featured in FIG. 6C has a perfect score of eight hundred (800).

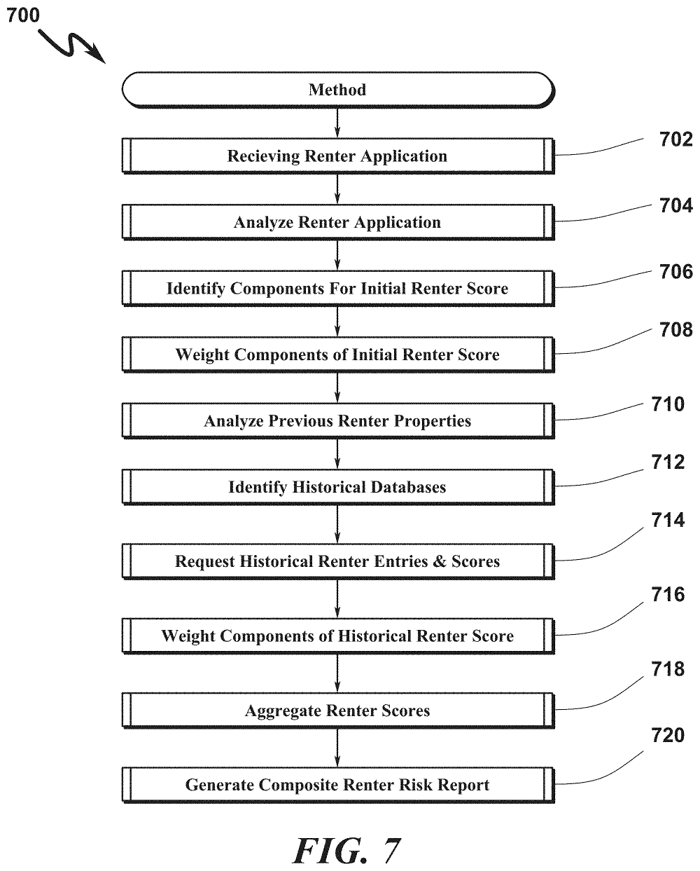

FIG. 7 is a block diagram of a method 700 for aggregating renter rating scores to generating a composite renter risk report. The asset holder may receive a renter application 702 with computing device. The renter application may be submitted through the internet by a user application run on a server owned and/or controlled by the asset holder, through email, by a paper copy which may be scanned by a digital scanner device to store the renter's application in a digital medium, or other means of receiving the application in digital form. Ideally, a properly completed renter application would have all of the necessary information to generate an initial renter risk score. After receiving the renter's application, the property owner may analyze the renter application 704 and identify the components 706 necessary to generate the initial renter risk score. Then, the property owner may weigh the components of the initial renter components 708 to generate the initial renter risk score.

Included in the prospective renter's application may be the renter's rental history. This may include locations and properties that the prospective renter has previously occupied as a renter. As the proposed renter's application is analyzed, previous renter properties may be analyzed 710. With the prospective renter's history, the property owner may identify historical databases 712. Depending on the circumstance, there may be one or more historical databases that may have data necessary to generate a historical renter risk score. If there is a centralized renter database such a renter history bureau, then all of a renter's history may be located at a single location and the property owner may only have to query a single database 714. However, if the prospective renter's history is not located at a single location, then the property owner may have to query several historical databases 714 to obtain all of the necessary components for the historical renter risk score.

After receiving all of the components of the historical renter risk score, the property owner may weigh the components of the historical renter score 716 to generate a historical renter risk score. The historical renter risk score may be aggregated 718 and weighed with the initial risk score to generate the composite renter score 720. If there are multiple sources of income, then all of the renter risk scores may be aggregated and weighed to generate a composite renter score 720 for the entire renter unit.

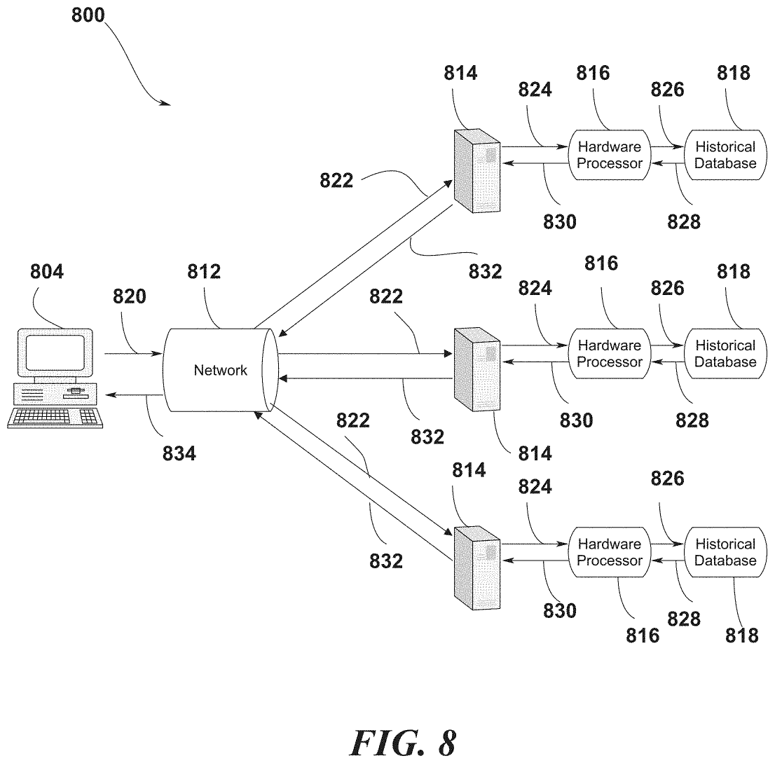

FIG. 8 is a schematic diagram of a system 800 for generating a composite historical renter rating score and retrieving one or more historical entries stored on one or more databases. One or more hardware processors 816 may be coupled to a corresponding server 814 which are accessible over a network 812, for example, the internet, by a user application on a computing device 804 such as a desktop computer or mobile device. The one or more hardware processors 816 may be configured to perform operations on the corresponding server 814 as the result of an interaction with a user or automatically without user involvement. For instance, the one or more hardware processors 816 may initiate a user session. The user session may be initiated when a user engages with the corresponding server 814 by inputting user credentials into a user interface on a user application on a computing device 804. The user credentials can be communicated 820 to the network 812 and then communicated 822 to one or more servers 814. Communication can occur over physical channels of communication or over wireless communicators. Often, a network 812 can be composed of a variety of segments that may have different means of communicating data.

The one or more hardware processors 816 may then receive 824 and process the user credentials from the corresponding servers 814 which then queries 826 a corresponding database 818 looking for a stored user ID that matches the user credentials. If a match is found, the one or more hardware processors 816 may, after retrieving 828 the corresponding matched stored user ID from the corresponding database 818, generate a unique session ID which is then communicated 830 to the corresponding server 814. In turn, the server 814 may communicate 832 the corresponding session ID through the network 812 so that it may be comunicated 834 to the user application on the computing device 804. The session ID may be temporary and can be used to reauthenticate the user at future points in time during the user session. The session ID can allow for the user application on the computing device 804 to be reauthorized without requiring user credentials to be resubmitted. In one or more examples, the session ID may be a token (also called a device token or push token) which can be a unique key for the app-device combination most notable used by push notification gateways. They allow for messages to be routed such that their delivery to the correct device, along with the correct application, as intended.

Once the user application on the computing device 804 has an associated session ID, a history request may then be entered into a user interface in the user application on the computing device 804. A history request can be a piece of data that easily identifies a person or entity that has had prior associated historical entries input into one or more of the historical databases 818. Typically, a history request can be names or identification numbers such as social security number and/or a full name and address. Furthermore, the historical request may query and retrieve the components necessary to generate a historical renter risk score. In one or more examples, the historical request may include a full name combined with a birthdate and social security number as the identifying segment of data used in the historical entries to associate the historical request with a stored entity and the corresponding historical renter risk score. Once received by the corresponding server 814 over the network 812, the corresponding hardware processor 816 may search 826 the corresponding historical database 818 for a matching stored entry and corresponding historical renter risk score components. If a match stored entry can be located, then the match stored entry is retrieved 828 by the hardware processor 816 and communicated 832 by the one or more servers 814 over the network 812 and communicated 834 to the user application on the computing device 804.

The user application on the computing device 804 may then receive one or more historical entries to be associated with the matched stored entry. Both can be communicated to one or more of the servers 814, then the corresponding hardware processor 816 stores the historical entry in the corresponding historical database 818 such that it is associated with the previously matched stored entry and may be retrieved later for compiling a historical renter risk score if the user has the appropriate credentials. The historical entry can be different types which can be dependent on the scope of privileges held by a user. If the user is a lessor, then the lessor may be able to create new historical entries that can detail a lessee history or store a new entry in the database. In one or more examples, a user that is a lessee may only store historical entries as a supplement to a previously created historical entry made by a lessor. Other examples, however, may allow for a lessee to make new historical entries without being a supplement to a previously lessor created historical entry. This could be done for the purpose of providing context to an event before the lessor has misrepresented the event or add positive history associated with the lessee to the database because the lessor is unwilling to do so. The new historical entry can now be searched for and displayed to a future authorized user of the database.

Various examples may also include the utilization of application programming interfaces (“API”) at various points in the disclosed system and method. An API is a computer interface that facilitates the interaction between multiple software intermediaries. It can provide mechanisms in which calls and requests can be made by one piece of software to another, data formats to use when utilizing a piece of software, and conventions to follow. APIs can be completely customized to a particular need or designed to conform to a particular industry standard. One example could include an API that the one or more hardware processors 816 use to query the corresponding hardware database 818 to match stored entries. Other APIs could be utilized in conjunction with the user application.

A common gateway interfaces (“CGI”) may be utilized by the disclosed system and method to generate web pages dynamically that are being executed by console applications being run on one or more of the servers 814. A CGI can be an interface specification for one or more of the servers 814 such as web servers to execute programs such as console application or command-line interface programs on one or more of the servers 814. In one or more examples, a CGI being run on one or more of the servers 814 may be used to process a historical request received from the user application (typically input by a user) and return the stored entry and/or a historical renter risk score to the user application on the computing device 804 after it has been retrieved by one or more of the hardware processors 816 that searched the corresponding historical database 818.

In one or more examples, the user application on a computing device 804 may receive a renter application which then may be analyzed to identify the components necessary to compile an initial renter risk score. The components may be weighed by the user application on the computing device 804 and an initial renter risk score may be generated. The user application on the computing device 804 may also analyze the renter's application to identify previous rented properties that may correspond with one or more historical databases 818. After communicating 820 to a network 812, the user application on the computing device 804 may be able to communicate with one or more servers 814 over the network 812. Then, a corresponding hardware processor 816 may query a corresponding historical database 818 for components need to compile a historical renter risk score. All of the queried components may be communicated back to the corresponding hardware processor 816 to then be communicated through the network 812 by the corresponding server 814. After the components are received by the user application on the computing device 804, the components are weighed and a historical renter risk score may be generated. In one or more examples, the user, through the user application on the computing device 804, may generate a composite renter rating report by aggregating all of the renter's initial renter risk scores and historical renter risk scores. The composite renter risk report may be utilized by the user to evaluate the potential renter(s) to make an informed decision on whether to agree to rent to the renter(s).

While this disclosure has been particularly shown and described with reference to preferred embodiments, it will be understood by those skilled in the art that various changes in form and detail may be made therein without departing from the spirit and scope of the invention. The investors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments but should be defined only in accordance with any claims and their equivalents issuing from this disclosure. Furthermore, the above advantages and features are provided in described embodiments but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading. Further, a description of a technology as background information is not to be construed as an admission that certain technology is prior art to any embodiments in this disclosure. Neither is the “Brief Summary” to be considered as a characterization of the embodiments(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of the claims shall be considered on their own merits in light of this disclosure but should not be constrained by the headings set forth herein.

We claim:

1. A method comprising:
initiating a user session between a user application and one or more servers;
receiving user credentials with one or more of the servers, wherein the user credentials are input into a user interface on the user application;
authenticating user credentials, wherein the user credentials are matched with a user ID;
determining scope of privileges associated with the user ID, wherein the scope of privileges is based on the type of user ID matched with the user credentials;
communicating a unique session ID to the user application, wherein the unique session ID is generated by one or more of the servers and associated with the user session;
receiving a history request with one or more of the servers, wherein the history request is input into the user interface on the user application;
searching a database with a data processor on the server for a stored entry that is a match to the history request, wherein the stored entry is comprised of one or more historical entries; and
communicating the matched stored entry to the user application.

2. The method of claim 1 further comprising:
receiving one or more historical entries with the server, wherein the one or more historical entries are input in the user interface on the user application;
associating the one or more historical entries with the matched stored entry; and
storing the one or more historical entries in the database.

3. The method of claim 1, wherein each of the one or more historical entries comprises one or more rental amount components, one or more rent term components, one or more payment history components, and one or more miscellaneous comment components.

4. The method of claim 1 further comprising:
analyzing a prospective renter application to identify one or more initial renter score components; and
generating an initial renter risk score by aggregating and weighing the initial renter score components.

5. The method of claim 4 further comprising:
analyzing a prospective renter application to identify one or more historical databases;
requesting one or more historical entries from one or more historical databases, wherein the one or more historical entries include historical renter components; and
generating a historical renter risk score by aggregating and weighing the historical renter score components.

6. The method of claim 5 further comprising:
generating a renter risk report by aggregating the initial renter risk score, the historical renter risk score, and one or more historical entries, wherein the initial risk score and the historical renter risk score are weighed.

7. The method of claim 1, wherein the user application communicates with the server through a network, wherein the unique session ID is a device token, wherein the data processor utilizes a first API when searching the database for the matched stored entry, wherein the matched stored entry is communicated to the user application by the server utilizing a CGI, and wherein the data processor utilizes a second API to store the one or more historical entries associated with the matched one or more historical entries.

8. A system comprising:
at least one hardware processor in communication with at least one non-transitory memory, wherein at least one hardware processor receives instruction read from the at least one non-transitory memory;
the at least one hardware processor is configured to command the system to perform operations comprising:
initiate a user session, wherein the user session is between a user application and at least one server, and wherein the at least one hardware processor is coupled to the corresponding server;
receive user credentials with the at least one server, wherein the user credentials are input into the user interface on the user application;
authenticate user credentials, wherein the at least one hardware processor is configured to query the non-transitory memory for a user ID that matches the user credentials;
determine the scope of privileges associated with the user ID with the at least one hardware processor, wherein the scope of privileges is dictated by type of the matched user ID;
communicate a unique session ID associated with the user session to the user application, wherein the unique session ID is generated by the at least one hardware processor on the at least one server after the user credentials are authenticated;
receive a history request with the at least one server, wherein the history request is input into the user interface on the user application;
search a database with the at least one hardware processor for a stored entry that matches the history request, wherein the stored entry is comprised of one or more historical entries, wherein the database is stored on the non-transitory memory; and
communicate the matched stored entry to the user application.

9. The system of claim 8 further comprising:
the at least one hardware processor further configured to command the system to perform operations comprising:
receive one or more historical entries with the server, wherein the one or more historical entries are input into the user interface on the user application;
associate the one or more historical entries with the matched stored entry; and
store the one or more historical entries in the database.

10. The system of claim 8 further comprising:
the at least one hardware processor further configured to command the system to perform operations comprising:
analyze a prospective renter application to identify one or more initial renter score components; and
generate an initial renter risk score, wherein the initial renter risk score is generated by aggregating and weighing the initial renter score components.

11. The system of claim 10 further comprising:
the at least one hardware processor further configured to command the system to perform operations comprising:
analyze a prospective renter application to one or more corresponding historical databases;
request one or more historical entries from one or more historical databases, wherein the one or more historical entries include historical renter components; and
generate a historical renter risk score, wherein the historical renter risk score is generated by aggregating and weighing the historical renter score components.

12. The system of claim 11 further comprising:
the at least one hardware processor further configured to command the system to perform operations comprising:
generate a renter risk report by aggregating the initial renter risk score, the historical renter risk score, and one or more historical entries, wherein the initial risk score and the historical renter risk score are weighed.

13. The system of claim 8, wherein the operations further comprise:
command the system to utilize a first API to search the database to match the stored entry with the historical request;
command the system to utilize a second API to store the one or more historical entries associated with the matched one or more historical entries; and
command the system to utilize a CGI to communicate the matched stored entry to the user application; and
wherein the unique session ID is a device token, wherein the authentication credentials comprise login information, and wherein the user application communicates with the server through a network

14. The system of claim 8, wherein each of the one or more historical entries comprises one or more rental amount components, one or more rent term components, one or more payment history components, and one or more miscellaneous comment components.

15. A non-transitory machine-readable medium having stored thereon machine-readable instructions executable to cause a machine to perform operations comprising:
initiating a user session between a user application and a server comprising:
receiving user credentials with the server, wherein the user credentials are input in a user interface on the user application;
authenticating user credentials, wherein the user credentials are matched with a user ID;
determining scope of privileges associated with the user ID, wherein the scope of privileges is based on the type of user ID matched with the user credentials;
communicating a unique session ID to the user application, wherein the unique session ID is generated by the server and associated with the user session;
receiving a history request with the server, wherein the history query is input in the user interface on the user application;
searching a database on the server for a stored entry that is a match to the history request, wherein the stored entry comprises one or more historical entries; and
communicating the matched stored entry to the user application.

16. The non-transitory machine-readable medium of claim 15, wherein operations further comprise:
receiving one or more historical entries with the server, wherein the one or more historical entries are input in the user interface on the user application;
associating the one or more historical entries with the matched stored entry; and
storing the one or more historical entries in the database.

17. The non-transitory machine-readable medium of claim 15, wherein operations further comprise:
analyzing a prospective renter application to identify one or more initial renter score components;
generating an initial renter risk score by aggregating and weighing the initial renter score components;
analyzing a prospective renter application to identify one or more corresponding historical databases;
requesting one or more historical entries from one or more historical databases, wherein the one or more historical entries include historical renter components; and
generating a historical renter risk score by aggregating and weighing the historical renter score components.

18. The non-transitory machine-readable medium of claim 17, wherein operations further comprise:
generating a renter risk report by aggregating the initial renter risk score, the historical renter risk score, and one or more historical entries, wherein the initial risk score and the historical renter risk score are weighed.

19. The non-transitory machine-readable medium of claim 15, wherein operations further comprise:
utilizing a first API to search the database to match the stored entry with the historical request;
utilizing a second API to store one or more historical entries associated with the matched one or more historical entries;
utilizing a CGI to communicate the matched stored entry to the user application; and
wherein the user application communicates with the server through a network, and wherein the unique session ID is a device token.

20. The non-transitory machine-readable medium of claim 15, wherein each of the one or more historical entries comprises one or more rental amount components, one or more rent term components, one or more payment history components, and one or more miscellaneous comment components.
